(19) United States
(12) Patent Application Publication
(10) Pub. No.: US 2026/0138025 A1
(43) Pub. Date: May 21, 2026

(54) VIRTUAL OBJECT CONTROL

(71) Applicant: Tencent Technology (Shenzhen) Company Limited, Shenzhen (CN)

(72) Inventor: Ziqi WEI, Shenzhen (CN)

(73) Assignee: Tencent Technology (Shenzhen) Company Limited, Shenzhen, GD (CN)

(21) Appl. No.: 19/449,399

(22) Filed: Jan. 14, 2026

Related U.S. Application Data
(63) Continuation of application No. PCT/CN2024/123371, filed on Oct. 8, 2024.

(30) Foreign Application Priority Data
Dec. 29, 2023 (CN) 202311867765.0

(51) Int. Cl. A63F 13/58

(52) U.S. Cl. CPC A63F 13/58

(57) ABSTRACT

In a virtual object control method, a reference image is obtained. A teleportation control element is output for display based on the reference image including information about a virtual environment. A first virtual object controlled by a player is teleported to a reference position in the virtual environment based on a trigger operation performed on the teleportation control element. The reference position is based on one of a position of a second virtual object in the virtual environment and a position associated with the reference image in the virtual environment.

### RELATED APPLICATIONS

The present application is a continuation of International Application No. PCT/CN 2024/123371, filed on Oct. 8, 2024, which claims priority to Chinese Patent Application No. 202311867765.0, filed on Dec. 29, 2023. The entire disclosures of the prior applications are hereby incorporated by reference.

### FIELD OF THE TECHNOLOGY

Aspects of this disclosure relate to the field of computer technologies, including a virtual object control method.

### BACKGROUND OF THE DISCLOSURE

With the continuous development of computer technologies, a quantity of players in a massively multiplayer online role-playing game (MMO) and an open world game is increasing. For the MMO or the open world game, a presentation effect of a virtual environment is beautiful and a scope of the virtual environment is large, and a player may control a virtual object to freely explore the virtual environment.

In a process in which the virtual object explores the virtual environment, many players record the virtual environment, for example, photograph the virtual environment.

### SUMMARY

Aspects of this disclosure provide a virtual object control method, a virtual object control apparatus, and a non-transitory computer-readable storage medium. Examples of technical solutions of this disclosure may be implemented as follows:
An aspect of this disclosure provides a virtual object control method. In the method, a reference image is obtained. A teleportation control element is output for display based on the reference image including information about a virtual environment. A first virtual object controlled by a player is teleported to a reference position in the virtual environment based on a trigger operation performed on the teleportation control element. The reference position is based on one of a position of a second virtual object in the virtual environment and a position associated with the reference image in the virtual environment.

An aspect of this disclosure provides a virtual object control apparatus. The apparatus includes processing circuitry configured to obtain a reference image. The processing circuitry is configured to output for display a teleportation control element based on the reference image including information about a virtual environment. The processing circuitry is configured to teleport a first virtual object controlled by a player to a reference position in the virtual environment based on a trigger operation performed on the teleportation control element. The reference position is based on one of a position of a second virtual object in the virtual environment and a position associated with the reference image in the virtual environment.

An aspect of this disclosure provides a virtual object control method, and the method includes: obtaining a reference image; displaying a teleportation control in response to the reference image including information about a virtual environment; and teleporting a currently controlled first virtual object to a reference position in the virtual environment in response to a trigger operation on the teleportation control, the reference position including a position of a second virtual object in the virtual environment or a position at which the reference image is photographed in the virtual environment.

An aspect of this disclosure provides a virtual object control apparatus, and the apparatus includes: an obtaining module, configured to obtain a reference image; a display module, configured to display a teleportation control in response to the reference image including information about a virtual environment; and a teleportation module, configured to teleport a currently controlled first virtual object to a reference position in the virtual environment in response to a trigger operation on the teleportation control, the reference position including a position of a second virtual object in the virtual environment or a position at which the reference image is photographed in the virtual environment.

An aspect of this disclosure provides a computer device, including a processor and a memory, the memory having at least one piece of program code stored therein, and the at least one piece of program code being loaded and executed by the processor, to cause the computer device to implement the foregoing virtual object control methods.

An aspect of this disclosure provides a non-transitory computer-readable storage medium storing instructions which, when executed by a processor, cause the processor to implement the foregoing virtual object control methods.

According to another aspect, a computer program or a computer program product is further provided, the computer program or the computer program product having at least one computer instruction stored therein, and the at least one computer instruction being loaded and executed by a processor, to cause a computer to implement the foregoing virtual object control methods.

In the technical solutions provided in the aspects of this disclosure, when the reference image includes the information about the virtual environment, the first virtual object is directly teleported to the reference position through triggering of the teleportation control, so that time for the first virtual object to search for the reference position in the virtual environment can be reduced, thereby improving efficiency of moving the first virtual object to the reference position. After the first virtual object moves to the reference position, a player controlling the first virtual object can observe a scene presented in the reference image, thereby facilitating improving efficiency of the player in observing the scene presented in the reference image, and improving game interactivity and game experience.

In addition, based on the first virtual object being directly teleported to the reference position, because the first virtual object does not need to search for the reference position in the virtual environment, each picture in a process in which the first virtual object searches for the reference position in the virtual environment does not need to be rendered, thereby facilitating reducing rendering resources, and improving running smoothness of the computer device.

### BRIEF DESCRIPTION OF THE DRAWINGS

FIG. 1 is a schematic diagram of an implementation environment of a virtual object control method according to an aspect of this disclosure.

FIG. 2 is a flowchart of a virtual object control method according to an aspect of this disclosure.

FIG. 3 is a schematic diagram of an interface for photographing a reference image according to an aspect of this disclosure.

FIG. 4 is a schematic diagram of an interface for sharing a reference image according to an aspect of this disclosure.

FIG. 5 is a schematic diagram of an interface for uploading a reference image according to an aspect of this disclosure.

FIG. 6 is a schematic diagram of an interface for detecting a reference image according to an aspect of this disclosure.

FIG. 7 is a schematic diagram of an interface for displaying prompt information according to an aspect of this disclosure.

FIG. 8 is a flowchart of a method for determining a reference position according to an aspect of this disclosure.

FIG. 9 is a flowchart of a method for matching a color feature of a reference image with color distribution of a virtual environment on a reference plane according to an aspect of this disclosure.

FIG. 10 is a flowchart of another method for determining a reference position according to an aspect of this disclosure.

FIG. 11 is a flowchart of another method for determining a reference position according to an aspect of this disclosure.

FIG. 12 is a schematic diagram of an interface for displaying a teleportation control according to an aspect of this disclosure.

FIG. 13 is a schematic diagram of an interface for displaying a first virtual object and a teleporter according to an aspect of this disclosure.

FIG. 14 is a schematic diagram of a third game interface according to an aspect of this disclosure.

FIG. 15 is a schematic diagram of an interface for displaying a reference image according to an aspect of this disclosure.

FIG. 16 is a schematic structural diagram of a virtual object control apparatus according to an aspect of this disclosure.

FIG. 17 is a schematic structural diagram of a terminal device according to an aspect of this disclosure.

FIG. 18 is a schematic structural diagram of a server according to an aspect of this disclosure.

### DETAILED DESCRIPTION

To make the objectives, technical solutions, and advantages of this disclosure clearer, the following describes aspects of this disclosure in further detail with reference to the accompanying drawings. The descriptions of the terms are provided as examples and are not intended to limit the scope of the disclosure.

The terms “first” and “second” of this disclosure are used to distinguish similar objects, but are unnecessarily used to describe a specific sequence or order. The terms used in such a way are interchangeable in proper circumstances, so that the aspects of this disclosure described herein can be implemented in other sequences than the sequence illustrated or described herein. The implementations described in the following aspects do not represent all implementations consistent with this disclosure. Instead, they are merely examples of apparatuses and methods consistent with some aspects related to this disclosure as recited in the appended claims.

Before the technical solutions of this disclosure are described, abbreviations and key terms in the aspects of this disclosure are first defined.

A virtual environment refers to an environment provided (or displayed) when an application program runs on a terminal device, and the virtual environment refers to an environment created for a virtual object to perform activities. The virtual environment may be a two-dimensional virtual environment, a 2.5-dimensional virtual environment, a three-dimensional virtual environment, or the like. The virtual environment may be a simulated environment of the real world, may be a semi-simulated environment of the real world, or may be a purely fictional environment. For example, the virtual environment involved in the aspects of this disclosure is the three-dimensional virtual environment.

A virtual object refers to a movable object in the virtual environment, and the movable object may be a virtual character, a virtual animal, an animation character, or the like. A player may manipulate the virtual object through a peripheral component or by tapping and touching a display screen. Each virtual object has a shape and a volume of the virtual object in the virtual environment, and occupies a part of space in the virtual environment. For example, when the virtual environment is the three-dimensional virtual environment, the virtual object is a three-dimensional model created based on an animation skeleton technology.

A third-person perspective refers to a perspective in which a virtual camera is at a position at a specific distance behind a virtual object controlled by the player in a game, and the virtual object controlled by the player and all elements in a surrounding environment can be seen in the virtual environment.

A first-person perspective refers to a subjective perspective of the player. From the first-person perspective, a game is played at the subjective perspective of the player.

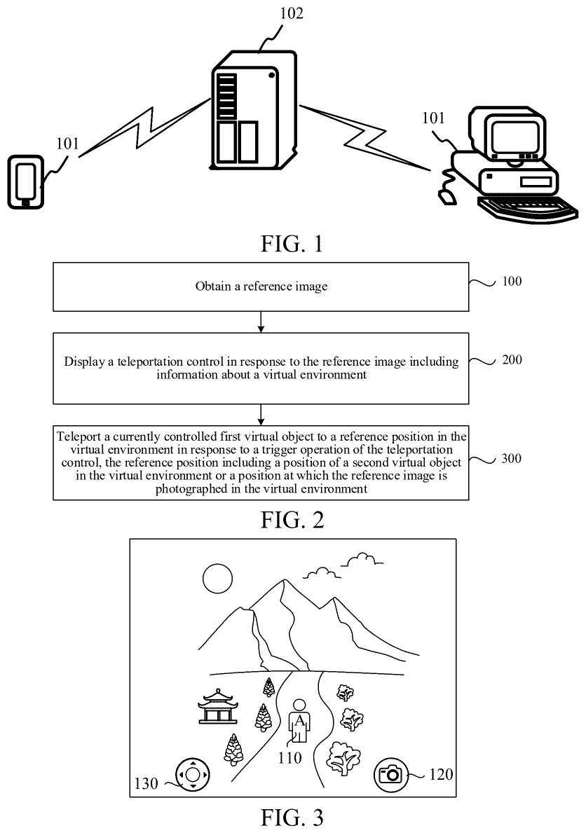

FIG. 1 is a schematic diagram of an implementation environment of a virtual object control method according to an aspect of this disclosure. As shown in FIG. 1, the implementation environment includes a terminal device 101 and a server 102.

A client that can provide a virtual environment is installed and run in the terminal device 101. For example, the terminal device 101 is configured to perform the virtual object control method provided in the aspects of this disclosure. The terminal device 101 displays a virtual object and a virtual environment including the virtual object.

For example, the client may be a game client, and the game client providing the virtual environment in the terminal device 101 may be an open world game, a third-person shooting (TPS) game, a first-person shooting (FPS) game, a multiplayer online battle arena (MOBA) game, a multiplayer shooting survival game, an MMO, or an action role playing game (ARPG). For example, the client may alternatively be a virtual reality (VR) client, an augmented reality (AR) client, a three-dimensional map program, a map simulation program, a social client, an interactive entertainment client, or the like.

The server 102 is configured to provide a background service for the client that is installed on the terminal device 101 and that can provide the virtual environment. In a possible implementation, the server 102 takes primary computing work, and the terminal device 101 takes secondary computing work. Alternatively, the server 102 takes secondary computing work, and the terminal device 101 takes primary computing work. Alternatively, the terminal device 101 and the server 102 use a distributed computing architecture to perform cooperative computing.

In some aspects, the terminal device 101 may be any electronic device product that can perform human-computer interaction with a user through one or more manners such as a keyboard, a touchpad, a remote control, voice interaction, or a handwriting device. For example, the terminal device 101 may be a smartphone, a tablet computer, a notebook computer, a desktop computer, a smart speaker, a smart watch, a personal computer (PC), a mobile phone, a personal digital assistant (PDA), a wearable device, a pocket PC (PPC), a smart infotainment, a smart television, or the like.

The terminal device 101 may refer to one of a plurality of terminal devices. The terminal device 101 is merely used as an example for description in the aspects. A person skilled in the art may learn that there may be more or fewer terminal devices 101. For example, there may be only one terminal device 101, or there may be dozens or hundreds of terminal devices 101, or more of terminal devices 101. A quantity of terminal devices 101 and device types are not limited in the aspects of this disclosure.

The server 102 is one of a server, or a server cluster including a plurality of servers, or any one of a cloud computing platform and a virtualization center. This is not limited in the aspects of this disclosure. The server 102 is in direct or indirect communication connection with the terminal device 101 in a wired or wireless communication manner. The server 102 has a data receiving function, a data processing function, and a data sending function. Certainly, the server 102 may also have another function. This is not limited in the aspects of this disclosure.

A person skilled in the art needs to understand that the terminal device 101 and the server 102 are merely examples for description, and other terminal devices or servers that are existing or that may appear in the future, if applicable to this disclosure, shall also fall within the scope of this disclosure, and are included herein by reference.

Aspects of this disclosure provide a virtual object control method. The method may be applied to the implementation environment shown in FIG. 1. A flowchart of a virtual object control method according to an aspect of this disclosure shown in FIG. 2 is used as an example. The method may be performed by a computer device. For example, the method may be performed by the terminal device 101 in FIG. 1, or may be performed by interaction between the terminal device 101 and the server 102. An example in which the terminal device 101 performs the method is used. As shown in FIG. 2, the method includes the following operation 100 to operation 300.

Operation 100: Obtain a reference image. For example, a reference image is obtained.

The reference image refers to an image that can indicate, when the reference image includes information about the virtual environment, a position of a second virtual object in a virtual environment or a position at which the reference image is photographed in the virtual environment. For example, the second virtual object may be a first virtual object, or may be another virtual object other than the first virtual object. For example, the first virtual object has an association relationship with the second virtual object. For example, the association relationship may include, and is not limited to, a friend relationship, a cooperative relationship in a same camp, a complementary relationship in different camps, or the like.

In an aspect of this disclosure, a terminal device performing the method may be a first terminal, and the first terminal is a terminal for a first player to control the first virtual object.

In an aspect, a manner of obtaining the reference image may be: obtaining the reference image uploaded by the first player. The first player may select the reference image from a local image gallery and upload the reference image to the first terminal. For example, the reference image uploaded by the first player may be an image photographed by the first player, or may be an image photographed by another player. This is not limited in the aspects of this disclosure. In this manner, the reference image can be obtained without interacting with another terminal, so that efficiency of obtaining the reference image is high.

For example, an upload control may be displayed in a client of the first terminal, and an image in the local image gallery of the first terminal may be displayed in response to a trigger operation on the upload control. The first player may select an image that the first player expects to upload from the image gallery, use the selected image in the image gallery as the reference image, and upload the reference image to the client.

In an aspect, a manner of obtaining the reference image may alternatively be: receiving the reference image transmitted by a control terminal of the second virtual object. Such a manner of obtaining the reference image may occur when the second virtual object is another virtual object other than the first virtual object. Based on such a manner of obtaining the reference image, another player can actively share a photographed image with the first player, which improves interaction between players, thereby improving interaction experience of players, and further improving a human-computer interaction rate.

An example in which the second virtual object is another virtual object other than the first virtual object is used for description in the aspects of this disclosure. The second virtual object is controlled by a second player through a second terminal, that is, a control terminal of the second virtual object is the second terminal. In other words, a terminal interacting with the first terminal is the second terminal, the second terminal controls the second virtual object, and the first virtual object may have another association relationship with the second virtual object. For example, the second virtual object has an association relationship with the first virtual object, so that the first virtual object and the second virtual object may interact in a game process. For example, the second virtual object and the first virtual object may be in a friend relationship. For another example, the second virtual object and the first virtual object may be in a non-friend relationship, but the second virtual object and the first virtual object may be in a same-camp relationship, or the second virtual object and the first virtual object may be in a different-camp relationship. This disclosure describes the association relationship between the second virtual object and the first virtual object as an example. This is not limited in this disclosure.

Regardless of the first terminal or the second terminal, a client that can provide the virtual environment may be installed and run in the terminal device. The client may be a client of any game, or may be a client of another type (for example, a virtual reality client, an augmented reality client, a three-dimensional map program, a map simulation program, a social client, or an interactive entertainment client). This is not limited in the aspects of this disclosure. For example, the client in the aspects of this disclosure is a game application program. In response to the application program receiving a start instruction, the terminal device displays a game pre-load interface of the application program. The game pre-load interface may include a virtual object selection interface, a player teaming interface, a map selection interface, a round game loading interface, and the like.

For example, the virtual environment is an environment provided by the application program of the terminal device. In the virtual environment, a plurality of virtual objects may be displayed, and different virtual objects may be controlled by different players. In addition to displaying the virtual object, the virtual environment may further display a virtual element. The virtual element may include a mountain, a plain, a river, a lake, an ocean, a desert, a swamp, drifting sand, a sky, a plant, a building, or the like. This disclosure describes a virtual environment as an example. This is not limited in this disclosure.

In an aspect of this disclosure, in a process in which the player controls the virtual object to explore in the virtual environment, the player may photograph and record the virtual environment. An example in which the second player controls the second virtual object to explore the virtual environment is used for description. FIG. 3 is a schematic diagram of an interface for photographing a reference image according to an aspect of this disclosure. As shown in FIG. 3, a second player may control a second virtual object 110 to move in a virtual environment through a virtual joystick 130. When expecting to record an image of the virtual environment, the second player may photograph and record the virtual environment through an image generation control 120, to obtain a reference image. The photographing operation may be completed based on a virtual camera in an application program, and a relative position between the virtual camera and the second virtual object 110 remains unchanged.

For example, a second terminal is a terminal of the second player, and the second player may control the second virtual object through the second terminal. For example, the second player controls the second virtual object to obtain the reference image by using the virtual camera. The virtual camera may be a virtual camera of a first-person perspective of the second virtual object. The virtual environment is photographed from the first-person perspective of the second virtual object, to obtain the reference image. In this case, the obtained reference image does not include the second virtual object. In some aspects, the virtual camera may be a virtual camera of a third-person perspective of the second virtual object. The virtual environment is photographed from the third-person perspective of the second virtual object, to obtain the reference image. In this case, the obtained reference image includes the second virtual object.

In the method provided in the aspects of this disclosure, in a process of obtaining the reference image, the second terminal obtains position information of an initial image in response to receiving a generation operation on the initial image, the position information including a position at which the initial image is obtained in the virtual environment, and associates the position information with the initial image, to obtain the reference image.

In an aspect of this disclosure, an application program of the second terminal receives a trigger operation on an image generation control, that is, the generation operation on the initial image, and may obtain the position information corresponding to the initial image. The generation operation on the initial image may include an image photographing operation. When the second player controls the second virtual object to use a first-person perspective camera to photograph an image, the position information may include position information of the second virtual object in the virtual environment, or may include orientation information of the second virtual object in the virtual environment. When the second player controls the second virtual object to use a third-person perspective camera to photograph an image, the position information may include the position information of the second virtual object in the virtual environment. After the position information is obtained, the position information is associated with the initial image. For example, a hidden watermark is formed in the initial image based on the position information, to obtain the reference image.

The information is associated with the initial image, so that the position information included in the reference image can be quickly determined in a subsequent process, and a teleported reference position is determined by using the position information, thereby improving, to some extent, efficiency of teleportation of the virtual object in a game process, reducing a data processing quantity, and saving resources consumed for data processing.

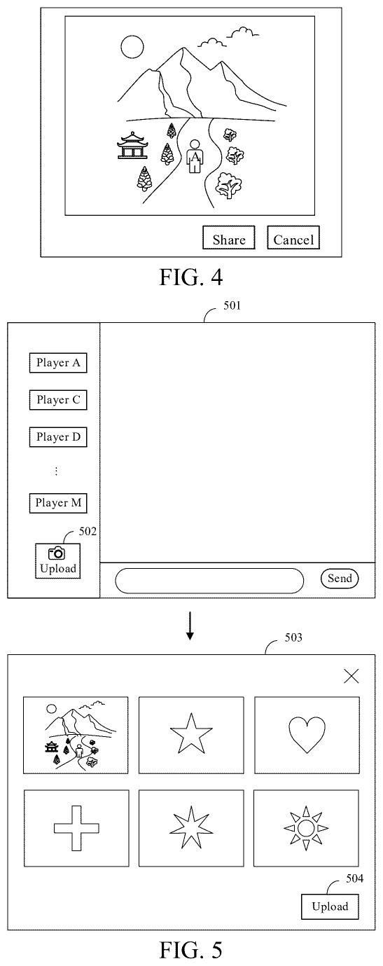

After obtaining the reference image, the second player may share the reference image with another player in the game. FIG. 4 is a schematic diagram of an interface for sharing a reference image according to an aspect of this disclosure. As shown in FIG. 4, the second player may send the reference image to another player through a sharing control in a game sharing interface. For example, if the second player sends the reference image to the first player, the first terminal of the first player may receive the reference image sent by the second terminal of the second player.

Alternatively, the first player may pre-obtain the reference image and locally store the reference image, and upload the reference image to a client supporting the virtual environment when needing to control the virtual object based on the reference image. FIG. 5 is a schematic diagram of an interface for uploading a reference image according to an aspect of this disclosure. As shown in FIG. 5, the first player may enter a chat interface 501 of the client. The chat interface 501 displays an upload control 502. After triggering the upload control 502, the first player may display an image selection interface 503. The image selection interface 503 displays a confirmation control 504 and an image in the image gallery. The first player may select an image that the first player expects to upload from the image gallery, and trigger the confirmation control 504. In response to a trigger operation on the confirmation control 504, the image selected by the first player is used as the reference image and is uploaded to the client.

An example in which the reference image is obtained by the second player photographing the virtual environment is merely used as an example for description. This is not limited in the aspects of this disclosure. In some aspects, the reference image may alternatively be obtained by the second player photographing another environment other than the virtual environment. In some other aspects, the reference image may alternatively be obtained by the first player photographing the virtual environment or another environment.

Operation 200: Display a teleportation control in response to the reference image including information about a virtual environment. For example, a teleportation control element is output for display based on the reference image including information about a virtual environment.

In an aspect of this disclosure, after the reference image is obtained, the reference image is detected. In response to detecting that the reference image does not include the information about the virtual environment, that is, the reference image is an image unrelated to the virtual environment, the obtained reference image is displayed. In some aspects, the teleportation control is displayed on a first game interface in response to detecting that the reference image includes the information about the virtual environment. The first game interface is a game interface in which the first virtual object participates, and the first virtual object may be a virtual object controlled by the first player based on the first terminal. In the aspects of this disclosure, the interface for displaying the teleportation control is referred to as the first game interface, and this is not limited in this disclosure, that is, the interface for displaying the teleportation control may have another name.

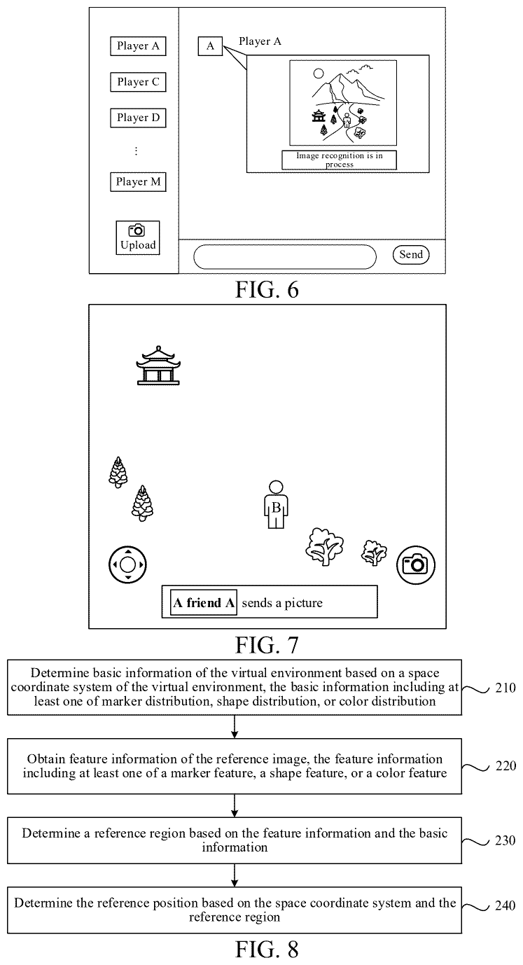

FIG. 6 is a schematic diagram of an interface for detecting a reference image according to an aspect of this disclosure. As shown in FIG. 6, after the reference image is obtained, the reference image is recognized, and “Image recognition is in process” is displayed below the reference image. For a case in which the reference image is an image uploaded by the first player, a player A in FIG. 6 is the first player, a virtual object controlled by the player A refers to a first virtual player, and a chat message of the player A may be considered as a message automatically sent by a system assistant. For a case in which the reference image is an image sent by the terminal of the second player, the player A in FIG. 6 refers to the second player, a virtual object controlled by the player A is a second virtual object, and a chat message of the player A is a chat message sent by the second player to the first player.

There may be one or more reference images. The reference image may be an image including the information about the virtual environment, or the reference image may be an image not including the information about the virtual environment. This disclosure describes a process of obtaining the reference image as an example, and a manner of obtaining the reference image and a quantity of reference images are not limited. Only one reference image is used as an example for description, and other reference images are not described again.

In the aspects of this disclosure, a manner of recognizing whether the reference image includes the information about the virtual environment is not limited, and may be implemented based on any image recognition method. Regardless of which image recognition method is used, after it is recognized that the reference image includes the information about the virtual environment, the teleportation control may be displayed on the first game interface. The first game interface is an interface of a game in which the currently controlled first virtual object participates. The teleportation control is configured to trigger teleportation of the first virtual object to the virtual environment included in the reference image. A display manner of the teleportation control is not limited in the aspects of this disclosure. The teleportation control may be displayed at any position of the first game interface, so that the player can trigger the teleportation operation.

In an aspect of this disclosure, for a case in which a manner of obtaining the reference image is receiving the reference image sent by the control terminal of the second virtual object, the method further includes: displaying prompt information in response to receiving the reference image, the prompt information being configured for prompting that the reference image is received, and content of the prompt information including at least one of an identity corresponding to the second virtual object or information about the reference image. For example, the prompt information is displayed on the first game interface. The prompt information is displayed, so that the first player can be intuitively prompted that the reference image is received, to facilitate the first player quickly viewing the reference image, thereby improving interaction efficiency, further improving interaction experience, and improving a human-computer interaction rate.

For example, after the prompt information is displayed, the method further includes: displaying, in response to a trigger operation on the prompt information, the chat message sent by the second player on the chat interface, the chat message including the reference image, so that the first player can intuitively view the reference image through the chat message.

For example, in a game process of the first player, the first terminal may display the first game interface, and the first game interface may be a current game interface. When the reference image sent by the second terminal is received, the prompt information may be displayed on the first game interface, to prompt the player that the reference image is received. In some aspects, the prompt information may be displayed in a form of a pop-up window. The prompt information includes information about the identity corresponding to the second virtual object and the reference image. For example, the prompt information may be that the player A sends a reference image. This disclosure describes a display manner of the prompt information and content of the prompt information. This is not limited in this disclosure.

The identity corresponding to the second virtual object may be any type of information that can identify an identity of the second virtual object. For example, the identity corresponding to the second virtual object may refer to an identity of a player (the second player) that controls the second virtual object. For example, the identity of the second player may refer to a nickname of the second player, or may refer to an identity document (ID) of the second player, or the like. The information about the reference image refers to information configured for identifying the reference image. For example, the information about the reference image may refer to a name of the reference image, or may refer to a thumbnail of the reference image.

For example, using an example in which the first player is a player B, an interface for displaying the prompt information may be shown in FIG. 7. The interface for displaying the prompt information shown in FIG. 7 refers to an interface of a process in which the player B controls a virtual object B to perform action in the virtual environment. Prompt information “A friend A sends a picture” is displayed in a lower region of the interface, and “Friend A” is the identity corresponding to the second virtual object.

Operation 300: Teleport a currently controlled first virtual object to a reference position in the virtual environment in response to a trigger operation on the teleportation control, the reference position including a position of a second virtual object in the virtual environment or a position at which the reference image is photographed in the virtual environment. For example, a first virtual object controlled by a player is teleported to a reference position in the virtual environment based on a trigger operation performed on the teleportation control element. The reference position is based on one of a position of a second virtual object in the virtual environment and a position associated with the reference image in the virtual environment.

In an aspect of this disclosure, before the first virtual object is teleported to the reference position in the virtual environment in response to the trigger operation on the teleportation control, a process of determining a reference position may further be included. The process of determining a reference position may include, and is not limited to, the following two manners.

Manner 1: Detect the reference image, and determine, in response to detecting that the reference image includes position information, the reference position based on the position information, the position information being configured for indicating a position of the second virtual object in the virtual environment or the position at which the reference image is photographed in the virtual environment. For example, the position information may be represented as a hidden watermark in the reference image. When it is detected that the reference image includes the hidden watermark, the position information in the hidden watermark is obtained, and the reference position is determined based on the position information. In this manner, the reference position can be directly determined based on the position information included in the reference image, thereby facilitating improving efficiency of determining the reference position, and further improving efficiency of teleporting the first virtual object to the reference position.

In another aspect of this disclosure, the reference position is determined based on the reference image and the virtual environment in response to that the reference image does not include the position information, for example, reference can be made to the following manner 2.

For the manner 2, a flowchart of a method for determining a reference image according to an aspect of this disclosure shown in FIG. 8 is used as an example. The process of determining a reference position may include operation 210 to operation 240.

Operation 210: Determine basic information of the virtual environment based on a space coordinate system of the virtual environment, the basic information including at least one of marker distribution, shape distribution, or color distribution. For example, basic information of the virtual environment is determined based on a spatial coordinate system of the virtual environment. The basic information includes a feature distribution.

In an aspect of this disclosure, the space coordinate system is created based on the virtual environment, and the space coordinate system may include a first direction, a second direction, and a third direction that are perpendicular to each other. The basic information of the virtual environment in the space coordinate system is obtained, where the basic information may include at least one of the marker distribution, the shape distribution, or the color distribution in the virtual environment.

The marker distribution is configured for indicating a position of a marker in the virtual environment. The marker in the virtual environment refers to a to-be-marked object in the virtual environment. A type of the marker in the virtual environment is not limited in the aspects of this disclosure. For example, the marker in the virtual environment may refer to all independent objects in the virtual environment, and for another example, the marker in the virtual environment may further refer to some types of objects in the virtual environment. For example, the marker in the virtual environment may be marked in a process of constructing the space coordinate system. With reference to FIG. 3, the marker in the virtual environment may include a pavilion, the sun, a mountain, a tree, or the like. The marker in the virtual environment is identified through a deep learning model, to obtain a label of the marker. Distribution of the marker may be obtained based on the label of the marker in a process of establishing the space coordinate system in the virtual environment. Using an example in which the marker is the pavilion, a label of the pavilion in the virtual environment may be retrieved, and distribution of the pavilion is determined based on a position of the label of the pavilion in the space coordinate system.

The shape distribution is configured for indicating shape information of each position in the virtual environment. For example, the virtual environment has a virtual element, and a shape of the virtual element in the virtual environment can be learned based on the shape distribution. The virtual element refers to an element having a clear shape in the virtual environment. The color distribution is configured for indicating color information of each position in the virtual environment. After the space coordinate system is established, the shape information and/or the color information of each position in the virtual environment may be determined with reference to the space coordinate system, to obtain the shape distribution and/or the color distribution.

For example, an example in which the first direction, the second direction, and the third direction in the space coordinate system respectively correspond to an X axis, a Z axis, and a Y axis is used. The marker distribution in the virtual environment and shape distribution and color distribution of the virtual element in the virtual environment are obtained based on the space coordinate system.

Operation 220: Obtain feature information of the reference image, the feature information including at least one of a marker feature, a shape feature, or a color feature. For example, feature information of the reference image is obtained.

For example, the feature information of the reference image is obtained by using the deep learning model, the feature information including at least one of the marker feature, the shape feature, or the color feature. The marker feature is configured for indicating a marker existing in the reference image, the shape feature is configured for indicating a shape existing in the reference image, and the color feature is configured for indicating a color existing in the reference image.

Operation 230: Determine a reference region based on the feature information and the basic information. For example, a reference region is determined based on the feature information and the basic information.

The reference region is a region corresponding to the reference image in the virtual environment. After the feature information of the reference image and the basic information of the virtual environment are obtained, the reference region is determined by comparing and considering the feature information and the basic information. The reference region refers to a region corresponding to the reference image in the virtual environment. The region corresponding to the reference image in the virtual environment refers to an imaging region corresponding to a scene in the virtual environment presented in the reference image in the virtual environment. In other words, after the scene in the virtual environment presented in the reference image is mapped to the reference region, an image whose presentation content is consistent with that of the reference image can be obtained.

After the feature information of the reference image is obtained, if the basic information includes the marker distribution, and the feature information of the reference image includes the marker feature, a process of determining the reference region based on the feature information of the reference image and the basic information corresponding to the virtual environment may include: determining a position region of the marker in the virtual environment based on the marker feature and the marker distribution; and determining the reference region based on the position region. The marker is a marker represented by the marker feature of the reference image. An association between the position region of the marker in the virtual environment and the reference region is strong. Determining the reference region based on the position region of the marker in the virtual environment is beneficial to improving reliability of determining the reference region, thereby further improving accuracy of a subsequently determined reference position, improving a control effect of the virtual object, further improving interaction experience, and improving a human-computer interaction rate.

For example, a process of determining the position region of the marker in the virtual environment based on the marker feature and the marker distribution may be: determining a target marking region in the virtual environment based on the marker feature and the marker distribution, the target marking region being the position region of the marker in the virtual environment.

For example, the feature information of the reference image may be detected, to determine whether the feature information of the reference image includes the marker feature. If the feature information includes the marker feature, the reference image includes the marker. If the feature information does not include the marker feature, the reference image does not include the marker.

In response to detecting that the feature information includes the marker feature, that is, the reference image includes the marker, the target marking region of the marker in the virtual environment is determined based on the marker feature and the marker distribution, the target marking region being the position region of the marker in the virtual environment.

In an aspect of this disclosure, a process of determining the position region of the marker in the virtual environment based on the marker feature and the marker distribution may include: obtaining a type of the marker; determining a marking region based on the type of the marker and the marker distribution, the marking region being a distribution region corresponding to the type of the marker; determining a related environmental feature of the marker; and selecting the marking region based on the related environmental feature, to obtain the position region. The marking region is first selected through the type of the marker, and then, the position region is selected based on the related environmental feature of the marker. Positions of all markers do not need to be compared based on the marker distribution, thereby facilitating improving efficiency of determining the position region, and further improving efficiency of determining the reference region and the reference position.

For example, the type of the marker is determined through the deep learning model. The type of the marker may be the label of the marker, for example, the label of the marker is the pavilion. First selecting is performed on the virtual environment based on the distribution of the pavilion, to obtain an initial marking region, the initial marking region being a region in which the pavilion is distributed in the virtual environment. Then, the related environmental feature of the marker may be further obtained. With reference to FIG. 3, the pavilion is located at the foot of the mountain, and there are trees around the pavilion. Second selecting is performed on a region in which the pavilion is distributed by using the related environmental feature, to obtain a position region satisfying the related environmental feature of the marker.

After the position region is determined, the reference region may be determined based on the position region.

In an aspect, a process of determining the reference region based on the position region includes: mapping the position region, to obtain the reference region. A manner of mapping the position region may be determined by analyzing and comparing a planar image of the marker in the reference image a form of the marker in the virtual environment, as long as a mapped image of the marker in the virtual environment is consistent or basically consistent with the planar image of the marker in the reference image after the position region is mapped.

In an aspect, a manner of determining the reference region based on the position region includes: determining, in the position region, the reference region based on the feature information of the reference image and the basic information corresponding to the virtual environment.

In an aspect of this disclosure, in response to that the reference image includes the marker, the reference image is matched with the position region of the virtual environment in the position region, and the reference region is determined by using a matching result; and in response to that the reference image does not include the marker, the reference image is matched with the virtual environment, and the reference region is determined by using a matching result. A process of matching the reference image with the virtual environment in the position region is similar to a process of directly matching the reference image with the virtual environment. An example in which the reference image is matched with the virtual environment is used for description in this disclosure.

In an aspect of this disclosure, a process of determining the reference region based on the feature information of the reference image and the basic information corresponding to the virtual environment may include: determining a reference plane based on the space coordinate system; mapping the basic information of the virtual environment on the reference plane, to obtain distribution information of the virtual environment on the reference plane; matching the distribution information of the virtual environment on the reference plane with the feature information corresponding to the reference image; and determining the reference region in the reference plane based on a matching result. The reference plane is determined, so that the reference region can be directly determined by matching information on a two-dimensional layer, and a three-dimensional region does not need to be converted into a two-dimensional region, thereby facilitating reducing a calculation amount in a process of determining the reference region, improving efficiency of determining the reference region, and further improving efficiency of determining the reference position.

For example, the first direction of the space coordinate system is used as a central axis, and the reference planes are disposed spaced apart at a particular angle. Similarly, the second direction and the third direction of the space coordinate system are used as central axes, and remaining reference planes are disposed spaced apart at a particular angle.

In an aspect of this disclosure, after a plurality of reference planes are determined, the shape distribution and the color distribution in the basic information of the virtual environment are mapped to the reference plane, to obtain the distribution information of the virtual environment on the reference plane. In other words, the distribution information of the virtual environment on the reference plane may include shape distribution information and color distribution information. The shape distribution information refers to shape distribution of the virtual environment on the reference plane, and the color distribution information refers to color distribution of the virtual environment on the reference plane.

In an aspect of this disclosure, matching is respectively performed based on the shape feature and the color feature of the reference image and the shape distribution and the color distribution of the virtual environment on the reference plane, to obtain a matching result of the shape feature and the shape distribution and a matching result of the color feature and the color distribution, and the reference region is determined in the reference plane by using the matching results.

In an aspect of this disclosure, matching is performed based on the shape feature of the reference image and the shape distribution of the virtual environment on the reference plane, to obtain a matching result of the shape feature and the shape distribution, and the reference region is determined in the reference plane by using the matching result. In an aspect of this disclosure, matching is performed based on the color feature of the reference image and the color distribution of the virtual environment on the reference plane, to obtain a matching result of the color feature and the color distribution, and the reference region is determined in the reference plane by using the matching result.

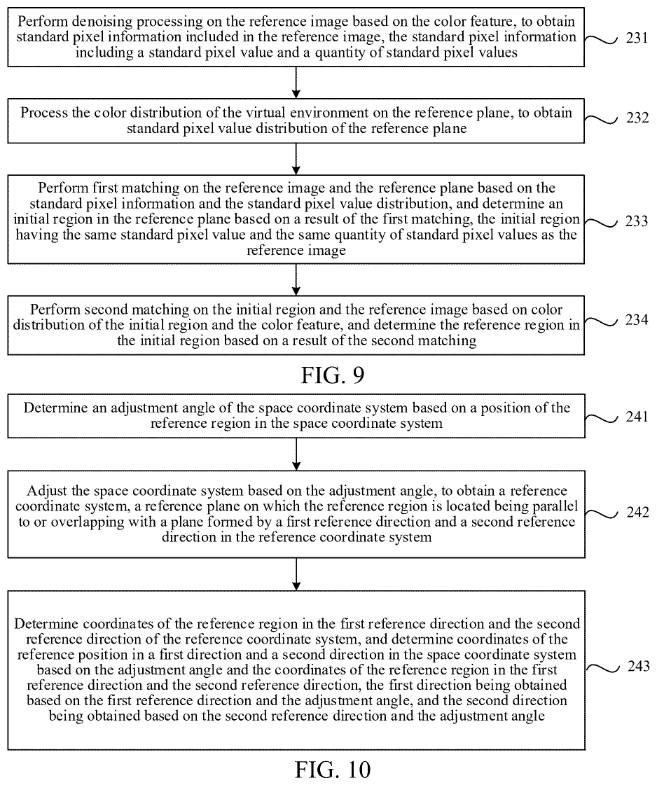

FIG. 9 is a flowchart of a method for matching a color feature of a reference image with color distribution of a virtual environment on a reference plane according to an aspect of this disclosure. As shown in FIG. 9, the matching the color feature of the reference image with the color distribution of the reference plane may include operation 231 to operation 234.

Operation 231: Perform denoising processing on the reference image based on the color feature, to obtain standard pixel information included in the reference image, the standard pixel information including a standard pixel value and a quantity of standard pixel values. For example, denoising processing is performed on the reference image based on the color feature to obtain standard pixel values and corresponding quantities.

For example, the reference image includes a plurality of pixel points, the color feature of the reference image may include a color value of each pixel point, and the color value of each pixel point may include an R (red) value, a G (green) value, and a B (blue) value. Denoising processing is performed on the reference image by using the color value of each pixel point. The denoising processing may include performing expansion and corrosion processing on the reference image, to remove a noise in the reference image. Then, the color value of the pixel point in the reference image obtained after expansion and corrosion processing is converted into the standard pixel information. The standard pixel information may include the standard pixel value. The standard pixel value may correspond to an RGB color value range. The color value corresponding to the pixel point may be converted into the standard pixel value based on the RGB color value range. Then, the reference image is divided based on the standard pixel value, to obtain the quantity of standard pixel values included in the reference image. For example, different color values corresponding to dark green, light green, grass green, and the like are all converted into a standard pixel value corresponding to green, to obtain a green color block in the reference image. Similarly, a color block of another color included in the reference image may be obtained, and further, a quantity of color blocks included in the reference image, that is, the quantity of standard pixel values, may be obtained. The standard pixel value and the RGB color value range corresponding to the standard pixel value may be set according to an actual situation. This is not limited in this disclosure.

Operation 232: Process the color distribution of the virtual environment on the reference plane, to obtain standard pixel value distribution of the reference plane. For example, the color distribution of the virtual environment is processed on the reference plane to obtain a standard pixel value distribution of the reference plane.

For example, the color distribution of the virtual environment on the reference plane may include a color value corresponding to a pixel point, and denoising processing is performed on the reference plane based on the color distribution of the virtual environment on the reference plane, to obtain the standard pixel value distribution of the reference plane. Performing denoising processing on the reference plane is similar to performing denoising processing on the reference image. Details are not described herein.

Expansion and corrosion processing is performed on the reference image and the reference plane, so that interference information in the reference image and the reference plane can be reduced, thereby facilitating converting the color value of the pixel point in the reference image and the reference plane into standard pixel information. The color value of the pixel point in the reference image is converted into the standard pixel value, and the quantity standard pixel values in the reference image is obtained, so that a quantity of data processing in a process of matching the color feature of the reference image with the color distribution of the reference plane can be reduced, thereby improving matching efficiency.

Operation 233: Perform first matching on the reference image and the reference plane based on the standard pixel information and the standard pixel value distribution, and determine an initial region in the reference plane based on a result of the first matching, the initial region having the same standard pixel value and the same quantity of standard pixel values as the reference image. For example, a first matching operation is performed between the reference image and the reference plane based on the standard pixel values and the standard pixel value distribution to determine an initial region in the reference plane, the initial region having a same standard pixel value and corresponding quantities as the reference image

For example, the reference plane is a projection plane of the virtual environment. Therefore, a size of the reference plane is much greater than a size of the reference image. A matching unit region and a matching interval are set in the reference plane, a size of the matching unit region being the same as the size of the reference image. The matching unit region is moved in a particular order in the reference plane based on the matching interval. During the movement, first matching is performed on the standard pixel value and the quantity of standard pixel values that are included in the matching unit region and the standard pixel value and the quantity of standard pixel values that are included in the reference image. If the matching unit region has the same standard pixel value and the same quantity of standard pixel values as the reference image, the matching unit region is used as the initial region, until the entire reference plane is matched, to obtain the initial region. For example, there are one or more initial regions.

Operation 234: Perform second matching on the initial region and the reference image based on color distribution of the initial region and the color feature, and determine the reference region in the initial region based on a result of the second matching. For example, a second matching operation is performed between the initial region and the reference image based on a color distribution of the initial region and the color feature to determine the reference region in the initial region.

In a process of determining the reference region based on information about the color, the initial region in which the standard pixel value is the same as the quantity of standard pixel values is first selected through first matching, then the reference region is selected through second matching, and the reference region is determined through two operations of selecting, thereby facilitating reducing a calculation amount in the process of determining the reference region, improving efficiency of determining the reference region, and further improving efficiency of determining the reference position.

For example, after the initial region is obtained, the color distribution of the initial region may be extracted from the color distribution of the virtual environment on the reference plane, and then second matching may be performed based on the color distribution of the initial region and the color feature of the reference image, to obtain the reference region.

For example, a process of performing second matching based on the color distribution of the initial region and the color feature of the reference image, to obtain the reference region may include: performing grid division on the initial region and the reference image based on a grid division parameter, to obtain a grid unit of the initial region and a grid unit of the reference image; determining, based on the color distribution of the initial region, a first pixel value corresponding to the grid unit of the initial region; determining, based on the color feature, a second pixel value corresponding to the grid unit of the reference image; and determining the initial region as the reference region in response to a quantity of grid units satisfying a reference condition in the initial region being greater than or equal to a first threshold. A similarity between the first pixel value corresponding to the grid unit satisfying the reference condition and the second pixel value corresponding to the corresponding grid unit in the reference image is greater than or equal to a similarity threshold. The initial region and the reference image are both divided into grid units, and whether the initial region is the reference region is determined by comparing pixel values of the grid units, thereby facilitating reducing an amount of calculation for determining whether the initial region is the reference region, improving efficiency of determining the reference region, and further improving efficiency of determining the reference position.

The similarity threshold may be set according to experience, or may be flexibly adjusted according to an application scenario. This is not limited in the aspects of this disclosure. For example, the similarity threshold may be 100%, and the first pixel value corresponding to the grid unit satisfying the reference condition is the same as the second pixel value corresponding to the corresponding grid unit in the reference image.

In an aspect of this disclosure, the grid division parameter may be a size of the grid, the initial region and the reference image are divided based on the grid division parameter, to obtain the grid unit of the initial region and the grid unit of the reference image, and the size of the grid may be set according to an actual situation. For example, the grid unit may be a single pixel, or the grid unit may include a plurality of pixels.

For example, a size of the initial region is the same as a size of the reference image. After grid division is performed on the initial region and the reference image based on a same grid division parameter, a size of the grid unit of the initial region is the same as a quantity of grid units of the reference image, and a quantity of grid units of the initial region is the same as the quantity of grid units of the reference image. In other words, the grid units of the initial region and the grid units of the reference image are in a one-to-one correspondence. A grid unit A in the initial region corresponding to a grid unit a in the reference image refers to a position of the grid unit A in the initial region being the same as a position of the grid unit a in the reference image.

After the grid units corresponding to the initial region and the reference image are obtained, the first pixel value corresponding to the grid unit of the initial region and the second pixel value corresponding to the grid unit of the reference image may further be determined. For example, when the grid unit includes a single pixel point, the first pixel value corresponding to the grid unit of the initial region may be determined through the color distribution of the initial region, and the second pixel value corresponding to the grid unit of the reference image may be determined through the color feature of the reference image. When the grid unit includes a plurality of pixel points, a pixel value of each pixel point in the grid unit of the initial region may be determined through the color distribution of the initial region, and then an average value of the pixel values is used as a first pixel value of the grid unit of the initial region, and similarly, a second pixel value of the grid unit of the reference image is obtained.

For example, the first pixel value and the second pixel value of the grid units corresponding to the initial region and the reference image are compared. In response to that a similarity between the first pixel value of a grid unit in the initial region and the second pixel value of a corresponding grid unit in the reference image is greater than or equal to the similarity threshold, the grid unit is used as a grid unit satisfying the reference condition in the initial region. The initial region is determined as the reference region in response to the quantity of grid units satisfying the reference condition in the initial region being greater than or equal to a first threshold. The first threshold may be set according to an actual situation. For example, the first threshold may be set to 90% of a total quantity of grid units of the reference image.

There are one or more initial regions. When there are a plurality of initial regions, operation 234 is performed for each initial region.

In an aspect of this disclosure, the reference image and the reference plane include a virtual element, when the feature information includes the shape feature, the distribution information of the virtual environment on the reference plane includes the shape distribution of the virtual environment on the reference plane, the distribution information of the virtual environment on the reference plane is matched with the feature information of the reference image, and a process of determining the reference region in the reference plane based on a matching result may include: determining a first contour of the virtual element based on the shape feature of the reference image; determining a second contour of the virtual element based on the shape distribution of the virtual environment on the reference plane; and determining a region corresponding to the second contour in the reference plane as the reference region in response to an overlapping rate of the first contour and the second contour being greater than or equal to a second threshold. The reference region is determined by comparing the overlapping rate of the contours of the virtual element, so that logic of determining the reference region is simple, thereby facilitating reducing a calculation amount of determining the reference region, improving efficiency of determining the reference region, and further improving efficiency of determining the reference position.

For example, the reference image includes the virtual element. With reference to FIG. 3, the virtual element may be a pavilion, the sun, a mountain, or a tree, and a contour of the virtual element may be obtained by using a contour detection algorithm or a contour detection function. Using an example in which the virtual element is a mountain, a first contour of the mountain in the reference image is obtained based on the feature information (for example, the shape feature) of the reference image, a second contour of the mountain on the reference plane is obtained based on the distribution information (for example, the shape distribution) of the virtual environment on the reference plane, then the first contour and the second contour are compared in segments, and if an overlapping rate of the first contour and the second contour is greater than or equal to the second threshold, a region on which the mountain is located and a region around the mountain are determined as the reference region.

For example, in a process of comparing the contours, overall shapes of the contours may be compared first, and a candidate region of a similar overall shape of the virtual element is determined. In the candidate region, detailed contour features in the virtual element are compared by using detailed features in the contours of the virtual element, such as sharpness of the contours and curvature of the contours, to obtain a region matching detailed features of the first contour and the second contour of the virtual element. Then, the overlapping rate of the first contour and the second contour is calculated in the region matching the detailed features, and the reference region is determined by using the overlapping rate of the first contour and the second contour.

In an aspect of this disclosure, the feature information includes the color feature and the shape feature, the distribution information of the virtual environment on the reference plane includes the color distribution and the shape distribution of the virtual environment on the reference plane, the distribution information of the virtual environment on the reference plane is matched with the feature information, and a process of determining the reference region in the reference plane based on a matching result includes: when the reference region is determined by matching the color distribution of the virtual environment on the reference plane with the color feature, and the reference region is also determined by matching the shape distribution of the virtual environment on the reference plane with the shape feature, using a union region or an intersection region of the two reference regions as the finally determined reference region in the reference plane. When the reference region is determined only by matching the color distribution of the virtual environment on the reference plane with the color feature, or the reference region is determined only by matching the shape distribution of the virtual environment on the reference plane with the shape feature, the determined reference region is directly used as the finally determined reference region in the reference plane.

The foregoing described process of determining the reference region by considering the information about the color and/or the information about the shape is described by using an example in which the reference region is determined based on the entire virtual environment. This is not limited in the aspects of this disclosure. In an aspect, the reference region may further be determined based on the position region of the marker in the virtual environment according to a similar principle by considering the information about the color and/or the information about the shape, to reduce a calculation amount of a process of determining the reference region and improve efficiency of determining the reference region and the reference position.

In the foregoing process of determining the reference region in the reference plane, only one reference plane is used as an example for description, and this is not limited in the aspects of this disclosure. There may also be a plurality of reference planes. When there are a plurality of reference planes, for each reference plane, processing is performed based on the foregoing manner of determining the reference region in the reference plane, until all reference planes are processed, and a reference region obtained after all reference planes are processed is used as a finally determined reference region. There may be one or more finally determined reference regions. This is not limited in the aspects of this disclosure.

Operation 240: Determine the reference position based on the space coordinate system and the reference region. For example, the reference position is determined based on the spatial coordinate system and the reference region.

The reference region corresponding to the reference image in the virtual environment is first determined by comparing the basic information of the virtual environment with the feature information of the reference image, and then the reference position is determined based on the reference region. A process of determining the reference position is highly standardized, thereby facilitating improving reliability of the determined reference position.

In an aspect of this disclosure, after the reference region is determined, the reference position may further be determined by using the space coordinate system and the reference region. FIG. 10 is a flowchart of a method for determining a reference position according to an aspect of this disclosure. As shown in FIG. 10, a process of determining the reference position may include operation 241 to operation 243.

Operation 241: Determine an adjustment angle of the space coordinate system based on a position of the reference region in the space coordinate system. For example, an adjustment angle of the spatial coordinate system is determined based on a position of the reference region in the spatial coordinate system.

For example, the position of the reference region in the space coordinate system is further determined by using the space coordinate system consisting of an X axis, a Y axis, and a Z axis that are perpendicular to each other. If the reference region is parallel to or overlaps with a plane formed by any two coordinate axes, the adjustment angle is 0°. If the reference region is not parallel to a plane formed by any two coordinate axes, the adjustment angle of the space coordinate system may be determined by using an angle between the plane formed by the coordinate axes and the plane on which the reference region is located.

Operation 242: Adjust the space coordinate system based on the adjustment angle, to obtain a reference coordinate system, a reference plane on which the reference region is located being parallel to or overlapping with a plane formed by a first reference direction and a second reference direction in the reference coordinate system. For example, the spatial coordinate system is adjusted based on the adjustment angle to obtain a reference coordinate system. A reference plane on which the reference region is located is parallel to or overlapping with a plane formed by a first reference direction and a second reference direction in the reference coordinate system.

For example, after the adjustment angle is determined, the space coordinate system may be rotated based on the adjustment angle, and a coordinate system after the rotation may be the reference coordinate system. In the reference coordinate system, the reference plane on which the reference region is located is parallel to or overlaps with the plane formed by the first reference direction and the second reference direction in the reference coordinate system, and the first reference direction and the second reference direction are perpendicular to each other. In this disclosure, an example in which the first reference direction and the second reference direction are an X′ axis and a Z′ axis is used. The reference plane on which the reference region is located is parallel to or overlaps with a plane formed by the X′ axis and the Z′ axis.

Operation 243: Determine coordinates of the reference region in the first reference direction and the second reference direction of the reference coordinate system, and determine coordinates of the reference position in a first direction and a second direction in the space coordinate system based on the adjustment angle and the coordinates of the reference region in the first reference direction and the second reference direction, the first direction being obtained based on the first reference direction and the adjustment angle, and the second direction being obtained based on the second reference direction and the adjustment angle. For example, coordinates of the reference region in the first reference direction and the second reference direction of the reference coordinate system are determined. Coordinates of the reference position in a first direction and a second direction in the spatial coordinate system are determined based on the adjustment angle and the coordinates of the reference region in the first reference direction and the second reference direction. The first direction is obtained based on the first reference direction and the adjustment angle. The second direction is obtained based on the second reference direction and the adjustment angle.

For example, a process of determining the coordinates of the reference position in the first direction and the second direction in the space coordinate system based on the adjustment angle and the coordinates of the reference region in the first reference direction and the second reference direction includes: determining coordinates of a photographing position in the first direction and the second direction in the space coordinate system based on the adjustment angle and the coordinates of the reference region in the first reference direction and the second reference direction in the space coordinate system, and determining the coordinates of the reference position in the first direction and the second direction in the space coordinate system based on the coordinates of the photographing position in the first direction and the second direction in the space coordinate system. The photographing position refers to a position of a virtual camera photographing the reference image in the virtual environment at a photographing moment of the reference image. Because a relative position relationship between the virtual camera and a reference virtual object is fixed, the coordinates of the reference position in the first direction and the second direction in the space coordinate system may be determined based on the coordinates of the photographing position in the first direction and the second direction in the space coordinate system and the relative position relationship between the virtual camera and the reference virtual object.

For example, a manner of determining the first direction includes: rotating the first reference direction by the adjustment angle, to obtain the first direction. A manner of determining the second direction includes: rotating the second reference direction by the adjustment angle, to obtain the second direction.

For example, an example in which the reference region is rectangular is used. After the reference region is determined, coordinates of a vertex and a center point of the reference region on the X′ axis and the Z′ axis in the reference coordinate system may be determined. Then, the coordinates of the vertex and the center point of the reference region on the X′ axis and the Z′ axis are converted into coordinates on the X axis and the Z axis in the space coordinate system by using the adjustment angle, so that the coordinates of the reference position on the X axis and the Z axis in the space coordinate system may be determined.

In an aspect of this disclosure, if the reference image includes the reference virtual object, a position at which the reference virtual object needs to be teleported to the reference region may be determined based on a relative position of the reference virtual object in the reference image, and coordinates of this position on the X axis and the Z axis are determined.

In an aspect of this disclosure, if the reference image does not include the reference virtual object, the reference virtual object needs to be teleported to a position at which the reference virtual object obtains the reference image, and the position at which the reference virtual object obtains the reference image may be coordinates on the X axis and the Z axis corresponding to the central point of the reference region.

Determining the reference position by comprehensively considering the coordinates of the reference position in the first direction and the second direction in the space coordinate system is beneficial to ensuring positioning accuracy of the reference position in the first direction and the second direction, thereby ensuring reliability of the reference position to a large extent, and further ensuring control reliability of the virtual object.

In an aspect of this disclosure, after the coordinates of the reference position in the first direction and the second direction in the space coordinate system are determined, coordinates of the reference position in a third direction in the space coordinate system may be further determined by using the reference image and the virtual element in the reference region, the third direction being perpendicular to the plane formed by the first direction and the second direction, and the third direction being obtained based on a third reference direction and the adjustment angle. For example, a manner of determining the third direction includes: rotating the third reference direction by the adjustment angle, to obtain the third direction.

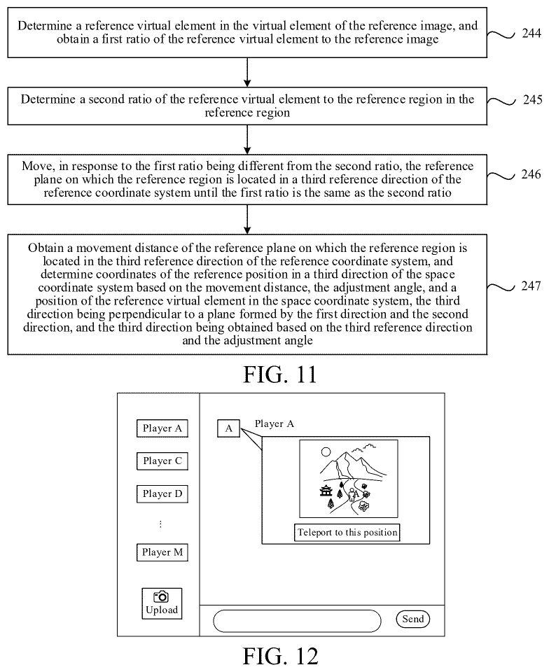

FIG. 11 is a flowchart of another method for determining a reference position according to an aspect of this disclosure. As shown in FIG. 11, a process of determining the reference position may include operation 244 to operation 247.

Operation 244: Determine a reference virtual element in the virtual element of the reference image, and obtain a first ratio of the reference virtual element to the reference image. For example, a reference virtual element in the reference image is determined. A first ratio of the reference virtual element to the reference image is obtained.

For example, the reference image may include a plurality of virtual elements, the reference virtual element is determined in the plurality of virtual elements, and there may be one or more reference virtual elements. For example, the reference virtual element is determined based on a volume of the virtual element and a contour of the virtual element. In some aspects, a virtual element having a medium volume and a regular shape is selected from the virtual elements as the reference virtual element. The virtual element having a medium volume and a regular shape facilitates calculating the first ratio of the reference virtual element to the reference image.

After the reference virtual element is determined, the first ratio of the reference virtual element to the reference image may be obtained. For example, an area of the reference virtual element and an area of the reference image are determined, and the first ratio of the reference virtual element to the reference image is calculated by using the area of the reference virtual element and the area of the reference image. For example, a ratio of the area of the reference virtual element to the area of the reference image is used as the first ratio of the reference virtual element to the reference image. In this disclosure, an example in which there is one reference virtual element is used. For example, the reference virtual element is a mountain, an area of the mountain is determined in the reference image, and the area of the mountain may be calculated based on a contour of the mountain in the reference image. For example, the reference image is divided into area units arranged in an array, a quantity of area units occupied by the contour of the mountain is determined, and a first ratio of the contour of the mountain to the entire reference image is further determined. In this disclosure, calculation of the first ratio of the reference virtual element to the reference image is used as an example for description, and there may be another calculation manner. This is not limited in this disclosure.

Operation 245: Determine a second ratio of the reference virtual element to the reference region in the reference region. For example, a second ratio of the reference virtual element to the reference region is determined.

For example, after the first ratio is determined, the second ratio of the same reference virtual object in the reference region may be determined. For example, in the reference region, a ratio of an area of the same reference virtual element to an area of the reference region is determined, to obtain the second ratio of the reference virtual element to the reference region. A process of calculating the second ratio is similar to a process of calculating the first ratio. Details are not described herein.

Operation 246: Move, in response to the first ratio being different from the second ratio, the reference plane on which the reference region is located in a third reference direction of the reference coordinate system until the first ratio is the same as the second ratio. For example, based on a determination that the first ratio is different from the second ratio, the reference plane is moved in a third reference direction of the reference coordinate system until the first ratio and the second ratio are equal.

For example, in response to the first ratio of the reference virtual element on the reference image being different from the second ratio of the reference virtual element on the reference region, the reference plane on which the reference region is located is moved in the third reference direction, that is, a direction of the Y′ axis, until the first ratio is the same as the second ratio. For example, the reference virtual element is the mountain, a proportion of the mountain to the reference image is 40%, when coordinates of the mountain are the same as coordinates on the Y′ axis in the reference region, the proportion of the mountain to the reference region is 0%. As the reference plane on which the reference region is located moves in the Y′ axis, the proportion of the mountain to the reference region increases until the proportion of the mountain to the reference region is 40%.

Operation 247: Obtain a movement distance of the reference plane on which the reference region is located in the third reference direction of the reference coordinate system, and determine coordinates of the reference position in a third direction of the space coordinate system based on the movement distance, the adjustment angle, and a position of the reference virtual element in the space coordinate system, the third direction being perpendicular to a plane formed by the first direction and the second direction, and the third direction being obtained based on the third reference direction and the adjustment angle. For example, coordinates of the reference position in a third direction of the spatial coordinate system are determined based on a movement distance of the reference plane in the third reference direction, the adjustment angle, and a position of the reference virtual element in the spatial coordinate system. The third direction is perpendicular to a plane formed by the first direction and the second direction. The third direction is obtained based on the third reference direction and the adjustment angle.

For example, a process of determining coordinates of the reference position in a third direction in the space coordinate system based on the movement distance, the adjustment angle, and a position of the reference virtual element in the space coordinate system includes: determining coordinates of the photographing position in the third direction in the space coordinate system based on the movement distance, the adjustment angle, and the position of the reference virtual element in the space coordinate system; and determining the coordinates of the reference position in the third direction in the space coordinate system based on the coordinates of the photographing position in the third direction in the space coordinate system. The photographing position refers to a position of a virtual camera photographing the reference image in the virtual environment at a photographing moment of the reference image. Because a relative position relationship between the virtual camera and the reference virtual object is fixed, the coordinates of the reference position in the third direction in the space coordinate system may be determined based on the coordinates of the photographing position in the third direction in the space coordinate system and the relative position relationship between the virtual camera and the reference virtual object.

For example, the movement distance of the reference plane on which the reference region is located in the third reference direction of the reference coordinate system is obtained, and the movement distance is converted into a movement distance in the space coordinate system based on the movement distance and the adjustment angle. Coordinates of the reference virtual element on the Y axis in the space coordinate system may be determined by using the contour of the reference virtual element in the space coordinate system. Coordinates of the photographing position on the Y axis are determined based on the movement distance of the reference plane on which the reference region is located in the space coordinate system and the coordinates of the reference virtual element on the Y axis in the space coordinate system. Further, coordinates of the reference position on the Y axis are determined based on the coordinates of the photographing position on the Y axis. The Y axis is the third direction of the space coordinate system, and the third direction is perpendicular to the plane formed by the first direction and the second direction.

To determine the reference position by comprehensively considering the coordinates of the reference position in the first direction and the second direction in the space coordinate system, and the coordinate of the reference position in the third direction in the space coordinate system is beneficial to improving reliability of the reference position. In addition, the coordinates of the reference position in the third direction in the space coordinate system are determined by comparing the ratio of the reference virtual element, so that reliability of the coordinates of the reference position in the third direction in the space coordinate system is high, thereby facilitating further improving the reliability of the reference position, further improving reliability of control of the virtual object, and improving interaction experience and a human-computer interaction rate of a player.

In an aspect of this disclosure, after the coordinates of the reference position are obtained, an orientation angle may further be determined by using the coordinates of the reference region and the reference position. For example, a process of determining the orientation angle includes: determining the reference point in the reference region; determining a first vector of the reference point and a second vector of the reference position based on the space coordinate system; and determining the orientation angle of the reference position by using the first vector and the second vector. The orientation angle includes, and is not limited to, an orientation angle of the reference position of the second virtual object in the virtual environment or an orientation angle of photographing the reference image in the virtual environment. The orientation angle is configured for restricting an orientation after the first virtual object is teleported to the reference position. In other words, after the first virtual object is teleported to the reference position, an orientation of the first virtual object at the reference position is the same as an orientation angle of the reference position of the second virtual object in the virtual environment or an orientation angle for photographing the reference image in the virtual environment, to ensure that after the first virtual object is teleported, the first player can directly view a scene presented by the reference image without adjusting the orientation of the first virtual object, thereby facilitating improving interaction experience of the first player, and improving a human-computer interaction rate.

For example, the reference point may be a center point of the reference region, and coordinates of the center point of the reference region are determined by using coordinates of the reference region in the space coordinate system. After the coordinates of the central point and the coordinates of the reference position are determined, the first vector corresponding to the central point and the second vector of the reference position may further be determined, and then a dot product calculation is performed on the first vector and the second vector, to determine the orientation angle of the reference position. For example, the first vector refers to a vector pointing from an origin of coordinates of the space coordinate system to the coordinates of the center point, and the second vector is a vector pointing from an origin of coordinates of the space coordinate system to the coordinates of the reference position.

For example, when the reference virtual object is in the reference image, the orientation angle is an orientation angle of the virtual camera photographing the reference image. When the reference virtual object is not in the reference image, the orientation angle is an orientation angle of the reference virtual object, that is, a to-be-teleported orientation angle of the first virtual object.

In an aspect of this disclosure, FIG. 12 is a schematic diagram of an interface for displaying a teleportation control according to an aspect of this disclosure. As shown in FIG. 12, the reference image sent by a player A is recognized, and after it is obtained through recognition that the reference image includes the information about the virtual environment, a teleportation control of “teleport to this position” is displayed around the reference image, the position being the reference position.

For example, after the first terminal receives the reference image sent by a terminal of the player A and displays the teleportation control, the first player taps the teleportation control, and the first terminal obtains a trigger operation on the teleportation control.

In an aspect, the method includes: displaying the first virtual object and a teleporter in response to the trigger operation on the teleportation control, the teleporter being located around the first virtual object, and the teleporter being configured for teleporting the first virtual object to the reference position. After the trigger operation on the teleportation control is obtained, the teleporter is displayed, so that a visual effect that the first virtual object is teleported to the reference position through the teleporter can be brought to the first player, thereby facilitating improving interaction experience of the first player, and improving a human-computer interaction rate.

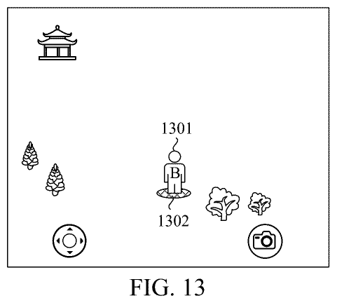

For example, locating around the first virtual object may refer to under the foot of the first virtual object, or may refer to another position. This is not limited in the aspects of this disclosure. An example in which locating around the first virtual object is under the foot of the first virtual object is used. An interface for displaying the first virtual object and the teleporter may be shown in FIG. 13. In FIG. 13, a teleporter 1302 is displayed under a foot of a first virtual object 1301.

In response to receiving a trigger operation on a teleportation control, a teleporter may be generated on a corresponding game interface, and a first virtual object is teleported to the reference position by using the teleporter. For example, after the first virtual object is teleported to the reference position, the teleporter may continue to be displayed, or may be canceled to be displayed. This is not limited in the aspects of this disclosure.

For example, a process of teleporting the first virtual object to the reference position in the virtual environment in response to a trigger operation on the teleportation control may include: displaying a second game interface in response to the trigger operation on the teleportation control, the second game interface including the first virtual object and the teleporter, the teleporter being located around the first virtual object, and the teleporter being configured for teleporting the first virtual object to the reference position.

For example, after the first virtual object is teleported to the reference position, the first virtual object located at the reference position is displayed. It can be ensured that the first player controlling the first virtual object views content presented in the reference image, thereby improving interaction experience and a human-computer interaction rate.

For example, the method further includes: displaying a third game interface, the third game interface including the reference position. The third game interface is an interface displayed when the first terminal teleports the first virtual object to the reference position.

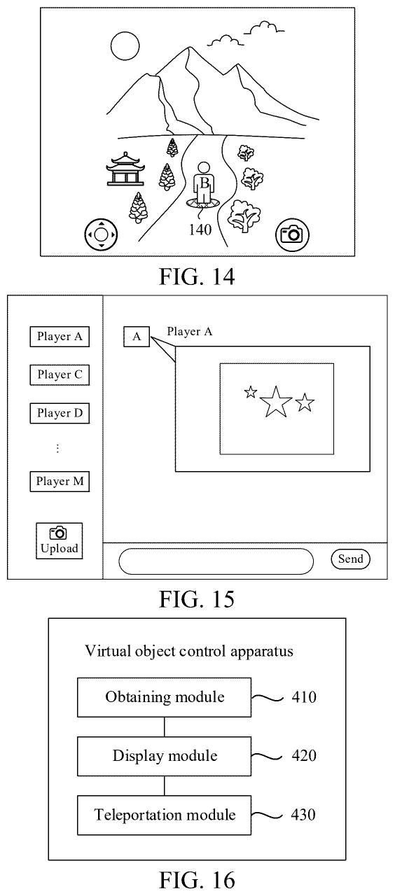

FIG. 14 is a schematic diagram of a third game interface according to an aspect of this disclosure. As shown in FIG. 14, after a player B taps a teleportation control, a teleporter 140 is generated around a first virtual object B controlled by the player B, and the first virtual object B is teleported to a reference position by using the teleporter 140. A virtual environment displayed on a third game interface is the same as a virtual environment displayed in a reference image.

In an aspect, the reference image may not include information about the virtual environment. In this case, only the reference image is displayed, and the teleportation control is not displayed. For example, an interface for displaying the reference image may be shown in FIG. 15. In the interface shown in FIG. 15, only the reference image is displayed, and the teleportation control is not displayed.

Because games such as an MMO and an open world game usually have a good environment presentation effect, many players photograph good scenery in a game scene to record, or invite a friend to take photos herein as a souvenir. However, many times, a player sees a photo that does not have a specific position, and cannot learn a specific position of the photo in the game, and browsing at the position is very difficult. If a friend is currently at a corresponding position, the player may be teleported to the position through a team invitation, but if a friend is not currently at the position, the player cannot come to that place.

According to the method provided in the aspects of this disclosure, after the reference image is obtained, the reference image can be quickly recognized based on an image recognition technology. For a case in which the reference image includes the information about the virtual environment, the teleportation control is displayed, and the first virtual object is directly teleported to the reference position after the teleportation control is triggered, so that time in which the first virtual object searches for the reference position in the virtual environment can be saved, thereby improving game interactivity and game experience.

In addition, after the reference position is quickly determined, the virtual object is quickly teleported to the specified position by using the teleporter. For example, photographing coordinate points are calculated by correcting a position corresponding to the reference image and a landscape element in a game, and a rapid teleportation manner is provided, so that a player can quickly arrive at the photographing position corresponding to a target position, thereby further improving an animation effect in a game process, and enriching game experience.

This disclosure further provides a virtual object control apparatus. FIG. 16 is a schematic structural diagram of a virtual object control apparatus according to an aspect of this disclosure. As shown in FIG. 16, the apparatus includes:
an obtaining module 410, configured to obtain a reference image;
a display module 420, configured to display a teleportation control in response to the reference image including information about a virtual environment; and
a teleportation module 430, configured to teleport a currently controlled first virtual object to a reference position in the virtual environment in response to a trigger operation on the teleportation control, the reference position including a position of a second virtual object in the virtual environment or a position at which the reference image is photographed in the virtual environment.

In a possible implementation, the second virtual object has an association relationship with the first virtual object, and the obtaining module 410 is configured to receive the reference image transmitted by a control terminal of the second virtual object.

In a possible implementation, the display module 420 is further configured to display prompt information in response to receiving the reference image, the prompt information being configured for prompting that the reference image is received, and content of the prompt information including at least one of an identity corresponding to the second virtual object or information about the reference image.

In a possible implementation, the display module 420 is further configured to display the first virtual object and a teleporter in response to the trigger operation on the teleportation control, the teleporter being located around the first virtual object, and the teleporter being configured for teleporting the first virtual object to the reference position.

In a possible implementation, the display module 420 is further configured to display the first virtual object located at the reference position.

In a possible implementation, the teleportation module 430 is further configured to: determine basic information of the virtual environment based on a space coordinate system of the virtual environment, the basic information including at least one of marker distribution, shape distribution, or color distribution; obtain feature information of the reference image, the feature information including at least one of a marker feature, a shape feature, or a color feature; determine a reference region based on the feature information and the basic information; and determine the reference position based on the space coordinate system and the reference region.

In a possible implementation, the basic information includes the marker distribution, the feature information includes the marker feature, and the teleportation module 430 is configured to: determine a position region of a marker in the virtual environment based on the marker feature and the marker distribution; and determine the reference region based on the position region.

In a possible implementation, the teleportation module 430 is configured to:
obtain a type of the marker; determine a marking region based on the type of the marker and the marker distribution, the marking region being a distribution region corresponding to the type of the marker; determine a related environmental feature of the marker; and select the marking region based on the related environmental feature, to obtain the position region.

In a possible implementation, the teleportation module 430 is configured to: determine a reference plane based on the space coordinate system; map the basic information of the virtual environment on the reference plane, to obtain distribution information of the virtual environment on the reference plane; match the distribution information of the virtual environment on the reference plane with the feature information; and determine the reference region in the reference plane based on a matching result.

In a possible implementation, the feature information includes the color feature, the distribution information of the virtual environment on the reference plane includes the color distribution of the virtual environment on the reference plane, and the teleportation module 430 is configured to: perform denoising processing on the reference image based on the color feature, to obtain standard pixel information included in the reference image, the standard pixel information including a standard pixel value and a quantity of standard pixel values; process the color distribution of the virtual environment on the reference plane, to obtain standard pixel value distribution of the reference plane; perform first matching on the reference image and the reference plane based on the standard pixel information and the standard pixel value distribution; determine an initial region in the reference plane based on a result of the first matching, the initial region having the same standard pixel value and the same quantity of standard pixel values as the reference image; perform second matching on the initial region and the reference image based on color distribution of the initial region and the color feature; and determine the reference region in the initial region based on a result of the second matching.

In a possible implementation, the teleportation module 430 is configured to: perform grid division on the initial region and the reference image based on a grid division parameter, to obtain a grid unit of the initial region and a grid unit of the reference image; determine, based on the color distribution of the initial region, a first pixel value corresponding to the grid unit of the initial region; determine, based on the color feature, a second pixel value corresponding to the grid unit of the reference image; and determine the initial region as the reference region in response to a quantity of grid units satisfying a reference condition in the initial region being greater than or equal to a first threshold, a similarity between the first pixel value corresponding to the grid unit satisfying the reference condition and the second pixel value corresponding to the corresponding grid unit in the reference image being greater than or equal to a similarity threshold.

In a possible implementation, the reference image and the reference plane include a virtual element, the feature information includes the shape feature, the distribution information of the virtual environment on the reference plane includes the shape distribution of the virtual environment on the reference plane, and the teleportation module 430 is configured to: determine a first contour of the virtual element based on the shape feature; determine a second contour of the virtual element based on the shape distribution of the virtual environment on the reference plane; and determine a region corresponding to the second contour in the reference plane as the reference region in response to an overlapping rate of the first contour and the second contour being greater than or equal to a second threshold.

In a possible implementation, the teleportation module 430 is configured to: determine an adjustment angle of the space coordinate system based on a position of the reference region in the space coordinate system; adjust the space coordinate system based on the adjustment angle, to obtain a reference coordinate system, a reference plane on which the reference region is located being parallel to or overlapping with a plane formed by a first reference direction and a second reference direction in the reference coordinate system; determine coordinates of the reference region in the first reference direction and the second reference direction of the reference coordinate system; and determine coordinates of the reference position in a first direction and a second direction in the space coordinate system based on the adjustment angle and the coordinates of the reference region in the first reference direction and the second reference direction, the first direction being obtained based on the first reference direction and the adjustment angle, and the second direction being obtained based on the second reference direction and the adjustment angle.

In a possible implementation, the reference image and the reference plane include the virtual element, and the teleportation module 430 is further configured to: determine a reference virtual element in the virtual element of the reference image; obtain a first ratio of the reference virtual element to the reference image; determine a second ratio of the reference virtual element to the reference region in the reference region; move, in response to the first ratio being different from the second ratio, the reference plane on which the reference region is located in a third reference direction of the reference coordinate system until the first ratio is the same as the second ratio; obtain a movement distance of the reference plane on which the reference region is located in the third reference direction of the reference coordinate system; and determine coordinates of the reference position in a third direction of the space coordinate system based on the movement distance, the adjustment angle, and a position of the reference virtual element in the space coordinate system, the third direction being perpendicular to a plane formed by the first direction and the second direction, and the third direction being obtained based on the third reference direction and the adjustment angle.

In a possible implementation, the teleportation module 430 is further configured to: determine a reference point in the reference region; determine a first vector of the reference point and a second vector of the reference position based on the space coordinate system; and determine an orientation angle of the reference position by using the first vector and the second vector.

In a possible implementation, the teleportation module 430 is further configured to: determine, in response to detecting that the reference image includes position information, the reference position based on the position information, the position information being configured for indicating a position of the second virtual object in the virtual environment or the position at which the reference image is photographed in the virtual environment.

According to the apparatus provided in the aspects of this disclosure, after the reference image is obtained, for a case in which the reference image includes the information about the virtual environment, the teleportation control is displayed, and the first virtual object is directly teleported to the reference position after the teleportation control is triggered, to save time in which the second virtual object searches for the reference position in the virtual environment, thereby improving efficiency of moving the first virtual object to the reference position. After the first virtual object moves to the reference position, a player controlling the first virtual object can observe a scene presented in the reference image, thereby facilitating improving efficiency of the player in observing the scene presented in the reference image, and improving game interactivity and game experience.

In addition, based on the first virtual object being directly teleported to the reference position, because the first virtual object does not need to search for the reference position in the virtual environment, each picture in a process in which the first virtual object searches for the reference position in the virtual environment does not need to be rendered, thereby facilitating reducing rendering resources, and improving running smoothness of the computer device.

The above functional modules are only described as examples when the apparatus provided above implements functions of the apparatus. In an actual application, the functions may be allocated to different functional modules according to specific needs. In other words, the internal structure of the apparatus is divided to different functional modules to complete all or some of the above described functions. In addition, the apparatus provided in the foregoing aspect and the method aspects belong to the same concept. For a specific implementation process, reference can be made to the method aspects. Details are not described herein again.

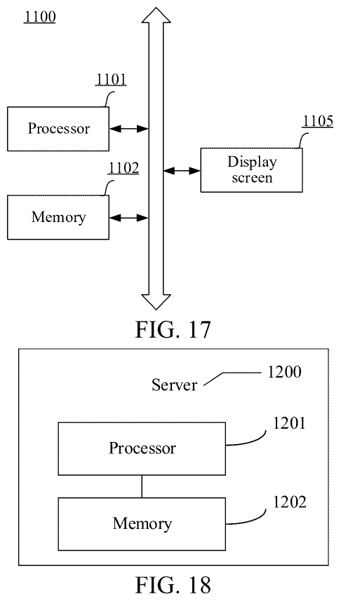

FIG. 17 is a block diagram of a structure of a terminal device 1100 according to an aspect of this disclosure. The terminal device 1100 may be any electronic device product that can perform human-computer interaction with a user through one or more manners such as a keyboard, a touchpad, a remote control, voice interaction, or a handwriting device. For example, the terminal device may be a personal computer (PC), a mobile phone, a smartphone, a personal digital assistant (PDA), a wearable device, a pocket PC (PPC), a tablet computer, a smart on board unit, a smart television, a smart speaker, a smart watch, or the like.

The terminal device 1100 includes a processor 1101 (an example of processing circuitry) and a memory 1102 (an example of a non-transitory computer-readable storage medium).

The processor 1101 may include one or more processing cores, such as a 4-core processor and an 8-core processor. The processor 1101 may be implemented in at least one hardware form of a digital signal processor (DSP), a field-programmable gate array (FPGA), and a programmable logic array (PLA). The processor 1101 may also include a main processor and a co-processor. The main processor is a processor configured to process data in an awake state, and is also referred to as a central processing unit (CPU). The co-processor is a low power consumption processor configured to process the data in a standby state. In some aspects, the processor 1101 may be integrated with a graphics processing unit (GPU). The GPU is configured to render and draw content that needs to be displayed on a display screen. In some aspects, the processor 1101 may further include an artificial intelligence (AI) processor. The AI processor is configured to process a computing operation related to machine learning.

The memory 1102 may include one or more computer-readable storage media. The computer-readable storage medium may be non-transient. The memory 1102 may also include a high-speed random access memory, a nonvolatile memory, such as one or more disk storage devices and flash storage devices. In some aspects, a non-transitory computer-readable storage medium in the memory 1102 is configured to store at least one instructions, and the at least one instructions are configured to be executed by the processor 1101, to implement the virtual object control method provided in the aspects of this disclosure.

In some aspects, the terminal device 1100 may further include a display screen 1105.

The display screen 1105 is configured to display a user interface (UI). The UI may include a graph, a text, an icon, a video, or any combination thereof. When the display screen 1105 is a touch display screen, the display screen 1105 further has a capability of collecting a touch signal on or above a surface of the display screen 1105. The touch signal may be inputted into the processor 1101 as a control signal for processing. In this case, the display screen 1105 may further be configured for providing a virtual button and/or a virtual keyboard, also referred to as a soft button and/or a soft keyboard. In some aspects, there may be one display screen 1105, and the display screen 1105 is arranged on a front panel of the terminal device 1100. In some other aspects, there may be at least two display screens that are respectively arranged on different surfaces of the terminal device 1100 or in a folded design. In some other aspects, the display screen 1105 may be a flexible display screen, and is arranged on a curved surface or a folded surface of the terminal device 1100. Even, the display screen 1105 may be set to be a non-rectangular irregular figure, that is, a special-shaped screen. The display screen 1105 may be prepared by using a material such as a liquid crystal display (LCD) or an organic light-emitting diode (OLED).

A person skilled in the art may understand that the structure shown in FIG. 17 does not constitute a limitation on the terminal device 1100, and the terminal may include more or fewer components than those shown in the figure, or combine some components, or have different component deployment.

FIG. 18 is a schematic structural diagram of a server according to an aspect of this disclosure. A server 1200 may vary greatly because of different configurations or performance, and may include one or more processors 1201 and one or more memories 1202. The one or more memories 1202 has at least one piece of program code stored therein. The at least one piece of program code is loaded and executed by the one or more processors 1201, to implement the virtual object control method according to the foregoing method aspects. Certainly, the server 1200 may further have components such as a wired or wireless network interface, a keyboard, and an input/output interface, to perform input/output. The server 1200 may further include other components configured to implement functions of the device. Details are not described herein.

In an aspect, a non-volatile computer-readable storage medium, such as a non-transitory computer-readable storage medium, is further provided. The non-volatile computer-readable storage medium has at least one piece of program code stored therein, and the at least one piece of program code is loaded and executed by a processor, so that a computer implements any one of the foregoing virtual object control methods.

In some aspects, the foregoing non-volatile computer-readable storage medium may be a read-only memory (ROM), a random access memory (RAM), a compact disc read-only memory (CD-ROM), a magnetic tape, a floppy disk, an optical data storage device, or the like.

In an aspect, a computer program or a computer program product is further provided, the computer program or the computer program product having at least one computer instruction stored therein, and the at least one computer instruction being loaded and executed by a processor, to cause a computer to implement the foregoing virtual object control method.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The “plurality” mentioned in this specification refers to two or more. The term “and/or” in this specification is an association relationship for describing associated objects, and indicates that three relationships may exist. For example, A and/or B may indicate the following three cases: Only A exists, both A and B exist, and only B exists. The character “/” indicates an “or” relationship between the associated objects.

The above-mentioned descriptions are merely example aspects of this disclosure, and are not intended to limit this disclosure. Any modification, equivalent replacement, or improvement made without departing from the principle of this disclosure needs to fall within the scope of this disclosure.

What is claimed is:

1. A virtual object control method, comprising:
obtaining, by processing circuitry, a reference image;
outputting for display a teleportation control element based on the reference image including information about a virtual environment; and
teleporting a first virtual object controlled by a player to a reference position in the virtual environment based on a trigger operation performed on the teleportation control element, the reference position being based on one of a position of a second virtual object in the virtual environment and a position associated with the reference image in the virtual environment.

2. The method according to claim 1, wherein the second virtual object is associated with the first virtual object, and the obtaining the reference image comprises:
receiving the reference image transmitted by a terminal of the second virtual object.

3. The method according to claim 2, further comprising:
outputting for display notification information based on receiving the reference image, the notification information including at least one of an identity of the second virtual object or information about the reference image.

4. The method according to claim 1, further comprising:
outputting for display a teleportation portal with the first virtual object based on the trigger operation performed on the teleportation control element, the teleportation portal being located around the first virtual object and configured to teleport the first virtual object to the reference position.

5. The method according to claim 1, further comprising:
outputting for display the first virtual object at the reference position.

6. The method according to claim 1, further comprising:
determining basic information of the virtual environment based on a spatial coordinate system of the virtual environment, the basic information including a feature distribution;
obtaining feature information of the reference image;
determining a reference region based on the feature information and the basic information; and
determining the reference position based on the spatial coordinate system and the reference region.

7. The method according to claim 6, wherein the basic information includes a marker distribution, the feature information includes a marker feature, and the determining the reference region based on the feature information and the basic information comprises:
determining a position region of a marker in the virtual environment based on the marker feature and the marker distribution; and
determining the reference region based on the position region.

8. The method according to claim 7, wherein the determining the position region of the marker in the virtual environment comprises:
obtaining a type of the marker;
determining a marking region based on the type of the marker and the marker distribution, the marking region being a distribution region corresponding to the type of the marker;
determining an environmental feature related to the marker; and
selecting the marking region based on the environmental feature to obtain the position region.

9. The method according to claim 6, wherein the determining the reference region based on the feature information and the basic information comprises:
determining a reference plane based on the spatial coordinate system;
mapping the basic information of the virtual environment onto the reference plane to obtain distribution information of the virtual environment on the reference plane; and
matching the distribution information of the virtual environment on the reference plane with the feature information to determine the reference region in the reference plane.

10. The method according to claim 9, wherein the feature information includes a color feature, the distribution information of the virtual environment on the reference plane includes a color distribution of the virtual environment on the reference plane, and the determining the reference region in the reference plane comprises:
performing denoising processing on the reference image based on the color feature to obtain standard pixel values and corresponding quantities;
processing the color distribution of the virtual environment on the reference plane to obtain a standard pixel value distribution of the reference plane;
performing a first matching operation between the reference image and the reference plane based on the standard pixel values and the standard pixel value distribution to determine an initial region in the reference plane, the initial region having a same standard pixel value and corresponding quantities as the reference image; and
performing a second matching operation between the initial region and the reference image based on a color distribution of the initial region and the color feature to determine the reference region in the initial region.

11. The method according to claim 10, wherein the second matching operation comprises:
dividing the initial region and the reference image into grid units based on a grid division parameter;
determining, based on the color distribution of the initial region, first pixel values corresponding to the grid units of the initial region;
determining, based on the color feature, second pixel values corresponding to the grid units of the reference image; and
determining the initial region as the reference region based on a quantity of grid units satisfying a reference condition in the initial region being greater than or equal to a first threshold, a similarity between the first pixel values and the second pixel values of corresponding grid units being greater than or equal to a similarity threshold.

12. The method according to claim 9, wherein the reference image and the reference plane includes a virtual element, the feature information includes a shape feature, and the distribution information of the virtual environment on the reference plane includes a shape distribution of the virtual environment on the reference plane, and the determining the reference region in the reference plane comprises:
determining a first contour of the virtual element based on the shape feature;
determining a second contour of the virtual element based on the shape distribution of the virtual environment on the reference plane; and
determining a region corresponding to the second contour in the reference plane as the reference region based on an overlap ratio between the first contour and the second contour being greater than or equal to a second threshold.

13. The method according to claim 6, wherein the determining the reference position based on the spatial coordinate system and the reference region comprises:
determining an adjustment angle of the spatial coordinate system based on a position of the reference region in the spatial coordinate system;
adjusting the spatial coordinate system based on the adjustment angle to obtain a reference coordinate system, a reference plane on which the reference region is located being parallel to or overlapping with a plane formed by a first reference direction and a second reference direction in the reference coordinate system;
determining coordinates of the reference region in the first reference direction and the second reference direction of the reference coordinate system; and
determining coordinates of the reference position in a first direction and a second direction in the spatial coordinate system based on the adjustment angle and the coordinates of the reference region in the first reference direction and the second reference direction, the first direction being obtained based on the first reference direction and the adjustment angle, and the second direction being obtained based on the second reference direction and the adjustment angle.

14. The method according to claim 13, further comprising:
determining a reference virtual element in the reference image;
obtaining a first ratio of the reference virtual element to the reference image;
determining a second ratio of the reference virtual element to the reference region;
based on a determination that the first ratio is different from the second ratio, moving the reference plane in a third reference direction of the reference coordinate system until the first ratio and the second ratio are equal; and
determining coordinates of the reference position in a third direction of the spatial coordinate system based on a movement distance of the reference plane in the third reference direction, the adjustment angle, and a position of the reference virtual element in the spatial coordinate system, the third direction being perpendicular to a plane formed by the first direction and the second direction, and the third direction being obtained based on the third reference direction and the adjustment angle.

15. The method according to claim 6, further comprising:
determining a reference point in the reference region;
determining a first vector of the reference point and a second vector of the reference position based on the spatial coordinate system; and
determining an orientation angle of the reference position based on the first vector and the second vector.

16. The method according to claim 1, further comprising:
based on a determination that the reference image includes position information, determining the reference position based on the position information, the position information indicating the one of a position of the second virtual object in the virtual environment and the position associated with the reference image in the virtual environment.

17. A virtual object control apparatus, comprising:
processing circuitry configured to:
obtain a reference image;
output for display a teleportation control element based on the reference image including information about a virtual environment; and
teleport a first virtual object controlled by a player to a reference position in the virtual environment based on a trigger operation performed on the teleportation control element, the reference position being based on one of a position of a second virtual object in the virtual environment and a position associated with the reference image in the virtual environment.

18. The apparatus according to claim 17, wherein the second virtual object is associated with the first virtual object, and the processing circuitry is configured to:
receive the reference image transmitted by a terminal of the second virtual object.

19. The apparatus according to claim 18, wherein the processing circuitry is configured to:
output for display notification information based on receiving the reference image, the notification information including at least one of an identity of the second virtual object or information about the reference image.

20. A non-transitory computer-readable storage medium storing instructions which, when executed by a processor, cause the processor to perform:
obtaining a reference image;
outputting for display a teleportation control element based on the reference image including information about a virtual environment; and
teleporting a first virtual object controlled by a player to a reference position in the virtual environment based on a trigger operation performed on the teleportation control element, the reference position being based on one of a position of a second virtual object in the virtual environment and a position associated with the reference image in the virtual environment.
